(19) United States
(12) Patent Application Publication
(10) Pub. No.: US 2024/0206597 A1
(43) Pub. Date: Jun. 27, 2024

(54) FOOTWEAR CONFIGURATION SYSTEM

(71) Applicant: Voyage Run Co., Boston, MA (US)

(72) Inventor: Brooke Torres, Boston, MA (US)

(21) Appl. No.: 18/557,264

(22) PCT Filed: Apr. 26, 2022
(86) PCT No.: PCT/US2022/026402

§ 371 Date: Oct. 25, 2023

Related U.S. Application Data
(60) Provisional application No. 63/179,662, filed on Apr. 26, 2021.

(51) Int. Cl. A43D 1/02; H04L 67/306

(52) U.S. Cl. CPC A43D 1/025; H04L 67/306

(57) ABSTRACT

Systems and methods for generating a footwear configuration are provided. A user input dataset related to footwear is received. A scan of a user foot is determined to be required based on the user input dataset. A request for the scan of the user foot is provided and the scan of the user foot is received in response to the scan of the user foot being required. A foot measurement representative of a portion of the user foot from the scan of the user foot is extracted. A configurable area of the footwear profile is adjusted based on the foot measurement. A recommended footwear configuration is generated based on the footwear profile and the adjusted configurable area.

### CROSS-REFERENCE TO RELATED APPLICATIONS

This application claims priority to U.S. Provisional Application No. 63/179,662 entitled “CUSTOM FOOTWEAR RECOMMENDATION AND CONFIGURATION SYSTEM” filed on Apr. 26, 2021, the disclosure of which is incorporated herein by reference in its entirety.

### TECHNICAL FIELD

The present disclosure relates to generating a footwear configuration. More particularly, the technology relates to computer architecture and operating methods for adjusting configurable areas of footwear based on user data gathered over a network.

### BACKGROUND

Computing systems can include a processor, a memory, a storage device, and input/output devices. The processor, the memory, the storage device, and the input/output devices can be interconnected via a system bus. The processor is capable of processing instructions for execution within the computing system. Such executed instructions can implement one or more components of, for example, a cloud server. The computing system may include input/output devices that can provide input/output operations for a network device. For example, the input/output device can include Ethernet ports or other networking ports to communicate with one or more wired and/or wireless networks (e.g., a local area network (LAN), a wide area network (WAN), the Internet) or hardware or software implemented communications switches placed within the networked environment.

In conventional server systems, data resources are made available to users over a network. A user of such a conventional server system typically retrieves data from and stores data on the system using the user's own systems. A user system might remotely access one of a plurality of server systems that might in turn access the server system. Data retrieval from the server system might include the issuance of a query from the user system to the server system. The server system might process the request for information received by the query and send to the user system information relevant to the request. But this query process with conventional server systems can only provide information related to existing footwear configurations.

Footwear is crucial for performance of athletes as well as for providing support, preventing feet from tiring out, and protecting from injuries with incorrectly fitting shoes (e.g., blisters, black nails, etc.). Accordingly, various techniques have been developed for configuring footwear. However, conventional systems are generally limited to only customizing size or width of a shoe. Conventional systems compromise footwear performance comfort by not considering footwear features, areas, and uses critical to individual users. Moreover, conventional server systems do not obtain information that considers footwear features, areas, and uses critical to individual users.

### SUMMARY

The present disclosure provides methods, devices, systems, and articles of manufacture for generating footwear configurations that may include receiving user input related to one or more foot measurements and analyzing the user input to adjust configurable areas.

In one aspect, a footwear configuration method is described that is configured to generate a recommendation of a footwear product with an adjusted configurable area. The method includes receiving, using at least one processor, a user input dataset related to footwear. The method includes comparing, using the at least one processor, the user input dataset against a plurality of footwear datasets, the user input dataset including at least one of a body measurement or an activity measurement. The method includes matching, using the at least one processor and based on the comparing, the user input dataset to a footwear dataset of the plurality of footwear datasets. The method includes generating, using the at least one processor and based on the matching, a footwear profile based on the user input dataset and the footwear dataset. The method includes determining, using the at least one processor and based on the user input dataset, a scan of a user foot is required. The method includes providing, using the at least one processor and in response to determining the scan of the user foot is required, a request for the scan of the user foot. The method includes receiving, using the at least one processor and in response to providing the request, the scan of the user foot. The method includes extracting, using the at least one processor, a foot measurement representative of a portion of the user foot from the scan of the user foot. The method includes adjusting, using the at least one processor, a configurable area of the footwear profile based on the foot measurement. The method includes generating, using the at least one processor, a recommended footwear configuration based on the footwear profile and the adjusted configurable area.

In some variations, the method further includes presenting, using the at least one processor, a query including at least one of the foot measurement or the user input dataset at a database communicatively coupled to the at least one processor, the database configured to store the plurality of footwear datasets representative of footwear profiles based on a plurality of user input datasets. Additionally, the method can include receiving, using the at least one processor and based on the plurality of footwear datasets, a customization of the configurable area associated with the footwear profile, the customization corresponding to the at least one of the foot measurement or the user input dataset satisfying a footwear feature threshold generated by the plurality of footwear datasets. Further, the method can include adjusting, using the at least one processor, the configurable area of the footwear profile based on the customization.

In some variations, the method can include generating, using the at least one processor, a model of the portion of the user foot. The method can include comparing, using the at least one processor, the model of the portion of the user foot to the plurality of footwear datasets in the database. The method can include matching, using the at least one processor, a feature of the model to the customization of the configurable area of the footwear profile, the customization corresponding to the at least one of the foot measurement or the user input dataset satisfying the footwear feature threshold generated by the plurality of footwear datasets. The method can include adjusting, using the at least one processor, the configurable area of the footwear profile based on the customization.

In some variations, the database can further include a set of tendencies for footwear profiles, the set of tendencies can be generated based on the plurality of footwear datasets, the footwear datasets can be representative of at least one of the body measurement or the activity measurement from other users, and a tendency of the set of tendencies can be representative of a correlation between the at least one of the body measurement or the activity measurement and a subset footwear dataset of the plurality of the footwear datasets having the at least one of the body measurement or the activity measurement, wherein the tendency corresponds to a customizable feature.

In some variations, the user input dataset is acquired from a client device communicatively coupled to the at least one processor. Further, the scan can be obtained from a scanning sensor communicatively coupled to the client device, the scanning sensor can be configured to perform at least one of capture images or obtain measurements, wherein the client device tracks a plurality of activities including training logs, race results, fitness activities, and user movement, and wherein the scanning sensor further comprises at least one of a 3D scanner, a camera, or a LIDAR.

In some variations, the method can further include generating, using the at least one processor, a user profile based on the recommended footwear and corresponding user input and user data. Additionally, the method can further include storing, using the at least one processor, the user profile in a database. Further, the method can include presenting, using the at least one processor, the recommended footwear based on the footwear profile and the adjusted configurable area.

Additionally, the configurable area of the footwear profile can include a combination of a footwear length, a footwear width, a footwear internal volume capacity, and a footwear volume distribution by area. Further, the body measurement can include at least one of a user foot length, an arch volume, a toe volume, an overall volume, a toe splay preference, and an arch preference. Additionally, the user input dataset can further include user location information, environment preferences, physical limitations, purchase history, aesthetic preferences, and static or moving body metrics. Further, the activity measurement can include user location information, environment preferences, physical limitations, purchase history, aesthetic preferences, and static or moving body metrics.

In another aspect, a footwear configuration system is described that is configured to generate a recommendation of a footwear product with an adjusted configurable area. The system can include at least one processor and at least one non-transitory storage media storing instructions that, when executed by the at least one processor, cause the at least one processor to perform operations comprising receiving a user input dataset related to footwear. The operations can include comparing the user input dataset against a plurality of footwear datasets, the user input dataset can include at least one of a body measurement or an activity measurement. The operations can include matching based on the comparing, the user input dataset to a footwear dataset of the plurality of footwear datasets. The operations can include generating, based on the matching, a footwear profile based on the user input dataset and the footwear dataset. The operations can include determining, based on the user input dataset, a scan of a user foot is required. The operations can include providing, in response to determining the scan of the user foot is required, a request for the scan of the user foot. The operations can include receiving, in response to providing the request, the scan of the user foot. The operations can include extracting a foot measurement representative of a portion of the user foot from the scan of the user foot. The operations can include adjusting a configurable area of the footwear profile based on the foot measurement. The operations can include generating a recommended footwear configuration based on the footwear profile and the adjusted configurable area.

In some variations, the system includes a database communicatively coupled to the processor, the database configured to store the plurality of footwear datasets representative of footwear profiles based on a plurality of user input datasets, wherein the operations further include presenting a query including at least one of the foot measurement or the user input dataset at the database. Additionally, the operations include receiving, based on the plurality of footwear datasets, a customization of the configurable area associated with the footwear profile, the customization corresponding to the at least one of the foot measurement or the user input dataset satisfying a footwear feature threshold generated by the plurality of footwear datasets. Further, the operations include adjusting the configurable area of the footwear profile based on the customization.

In some variations, the operations include generating a model of the portion of the user foot. The operations can include comparing the model of the portion of the user foot to the plurality of footwear datasets in the database. The operations can include matching a feature of the model to the customization of the configurable area of the footwear profile, the customization corresponding to the at least one of the foot measurement or the user input dataset satisfying the footwear feature threshold generated by the plurality of footwear datasets. The operations can include adjusting the configurable area of the footwear profile based on the customization.

In some variations, the database further includes a set of tendencies for footwear profiles, the set of tendencies generated based on the plurality of footwear datasets, the footwear datasets being representative of at least one of the body measurement or the activity measurement from other users, and a tendency of the set of tendencies being representative of a correlation between the at least one of the body measurement or the activity measurement and a subset footwear dataset of the plurality of the footwear datasets having the at least one of the body measurement or the activity measurement, wherein the tendency corresponds to a customizable feature.

In some variations, the system includes a client device configured to acquire the user input dataset from a user. Additionally, the system can include a scanning sensor communicatively coupled to the client device, the scanning sensor configured to perform at least one of capture images or obtain measurements. Further, the client device tracks a plurality of activities including training logs, race results, fitness activities, and user movement. Additionally, the scanning sensor can further include at least one of a 3D scanner, a camera, or a LIDAR.

In some variations, the operations include generating a user profile based on the recommended footwear and corresponding user input and user data. Additionally, the operations include storing the user profile in a database. Further, the operations include presenting the recommended footwear based on the footwear profile and the adjusted configurable area.

Additionally, the configurable area of the footwear profile includes a combination of a footwear length, a footwear width, a footwear internal volume capacity, and a footwear volume distribution by area. Further, the body measurement includes at least one of a user foot length, an arch volume, a toe volume, an overall volume, a toe splay preference, and an arch preference. Additionally, the user input dataset further includes user location information, environment preferences, physical limitations, purchase history, aesthetic preferences, and static or moving body metrics. Further, the activity measurement includes user location information, environment preferences, physical limitations, purchase history, aesthetic preferences, and static or moving body metrics.

In yet another aspect, a non-transitory computer-readable storage medium is described that is configured to generate a recommendation of a footwear product with an adjusted configurable area. The non-transitory computer-readable storage medium comprising at least one program for execution by one or more processors of a first device, the at least one program including instructions which, when executed by the one or more processors, cause the first device to perform operations including receiving a user input dataset related to footwear. The operations include comparing the user input dataset against a plurality of footwear datasets, the user input dataset including at least one of a body measurement or an activity measurement. The operations include matching based on the comparing, the user input dataset to a footwear dataset of the plurality of footwear datasets. The operations include generating, based on the matching, a footwear profile based on the user input dataset and the footwear dataset. The operations include determining, based on the user input dataset, a scan of a user foot is required. The operations include providing, in response to determining the scan of the user foot is required, a request for the scan of the user foot. The operations include receiving, in response to providing the request, the scan of the user foot. The operations include extracting a foot measurement representative of a portion of the user foot from the scan of the user foot. The operations include adjusting a configurable area of the footwear profile based on the foot measurement. The operations include generating a recommended footwear configuration based on the footwear profile and the adjusted configurable area.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates a footwear configuration system according to an exemplary embodiment of the present disclosure;

FIG. 2 illustrates a system diagram illustrating an example of a footwear configuration system according to an exemplary embodiment of the present disclosure;

FIG. 3 illustrates a configuration output table including configuration outputs based on user input data according to an exemplary embodiment of the present disclosure;

FIGS. 4A-4D illustrate different views of an example of footwear profiles according to an exemplary embodiment of the present disclosure;

FIG. 5 illustrates a guided consultative experience table representative of the guided consultative experience according to an exemplary embodiment of the present disclosure;

FIG. 6 illustrates an experienced consultative experience table representative of a consultative experience for more experienced users according to an exemplary embodiment of the present disclosure;

FIGS. 7A-7C illustrate different configurations of the midsole volume according to an exemplary embodiment of the present disclosure;

FIG. 8A illustrates an offset representative of the height difference between the heel and toe regions according to an exemplary embodiment of the present disclosure;

FIG. 8B illustrates an offset table showing different configuration possibilities in which the offset varies according to an exemplary embodiment of the present disclosure;

FIGS. 9A-9C illustrate tread variations according to an exemplary embodiment of the present disclosure;

FIGS. 10A-10C illustrate insoles having different levels of arch support according to an exemplary embodiment of the present disclosure;

FIG. 10D illustrates an insole configuration table including insoles with varying pad thicknesses and arch volumes for each insole according to an exemplary embodiment of the present disclosure;

FIG. 11 illustrates a footwear configuration process according to an exemplary embodiment of the present disclosure; and

FIG. 12 illustrates a block diagram depicting an example of a computing system consistent with implementations of the current subject matter.

The figures may not be to scale in absolute or comparative terms and are intended to be exemplary. The relative placement of features and elements may have been modified for the purpose of illustrative clarity. Where practical, the same or similar reference numbers denote the same or similar or equivalent structures, features, aspects, or elements, in accordance with one or more embodiments.

### DETAILED DESCRIPTION

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The present disclosure provides systems and methods for generating footwear configurations to achieve a more comfortable and suitable footwear for a user and a footwear product configurable to be relevant to the type of activity to be performed by a user.

The systems and processes described herein solve data and configuration problems associated with identifying, designing, and assembling footwear products that are suitable for activities to be performed by specific users. The systems and processes solve the data and configuration problems by adjusting configurable areas of the footwear profiled based on foot measurements obtained by scans (e.g., scanned images) of the user foot. Additionally, the systems and processes solve the data and configuration problems by generating a recommended footwear based on a footwear profile and the adjusted configurable area. In some embodiments, the systems and processes generate the recommended footwear configurations based on matching the user input dataset to a footwear dataset of the plurality of footwear datasets. Generating the footwear profile and matching the user input dataset to a footwear dataset involves applying a footwear algorithm and prompting a client device for scans (e.g., scanned images) of the foot. The technical solutions of the systems and processes described herein aim to provide specific users with an improved experience in identifying and designing footwear products that take into consideration unique foot characteristics as well as user lifestyle, environment, or behavior.

As described previously, conventional systems are generally limited to customizing size or width of a shoe for a user. Conventional systems compromise footwear performance comfort by not considering footwear features, areas, and uses critical to individual users. Moreover, conventional server systems do not involve the user querying information across a network that considers footwear features, areas, and uses critical to individual users.

The footwear configuration system described herein solves the data and configuration problems related to the limited configurations available through conventional systems. For example, the footwear configuration systems and methods described herein enable footwear configurations to further personalize the footwear based on additional characteristics from varied sources including user surveys, sensor information, body measurements, experience, environment, personal preference, and the like. The footwear configuration system described herein solves the problems related to a conventional server system's inability to obtain information about a user foot features and characteristics for configuring the footwear. For example, the footwear configuration systems and methods described herein enable a server to gather information related to a user foot features and characteristics not otherwise accessible using known data retrieval methods from conventional server systems.

The footwear configuration system enables further configuration of a footwear profile generated by the user input dataset. In some embodiments, the user input dataset includes a user survey results that may be used to identify foot features to be adjusted or configured. For example, a preference for a manufacturer based on user comfort may be included in the user input dataset to identify a footwear profile ideal for the user or configurable features to be adjusted. In another example, a user may indicate that a particular adjusted feature that was previously configured was satisfactory or requires further adjustment. In another embodiment, the footwear configuration system may be communicatively coupled to various sensors to gather information related to foot measurements for the user. For example, the footwear configuration system may include a sensor configured to scan a user foot to provide feedback on features such as the arch of a foot, volume of the foot, ankle tilt, or the like. In another example, the sensor data gathered from the sensor may also include feedback regarding pressure points along the foot.

Additionally, the footwear configuration system removes the need to consult a footwear expert. More importantly, the footwear configuration system detects information about a user foot that a footwear expert could not otherwise perceive. That is, the footwear customization system is configured to obtain measurements that a footwear expert would not be able to otherwise measure and then present one or more adjustable options. This is ideal for inexperienced users and experienced users alike who can be guided through a process to determine the appropriate footwear. Additionally, experienced footwear users can be presented with options to directly select which regions of the footwear are desired to be customized or configured. Even when an experienced user selects a variety of configurable areas, the footwear configuration system is configured to further tune the configuration by matching a particular fit with desired areas to be configured.

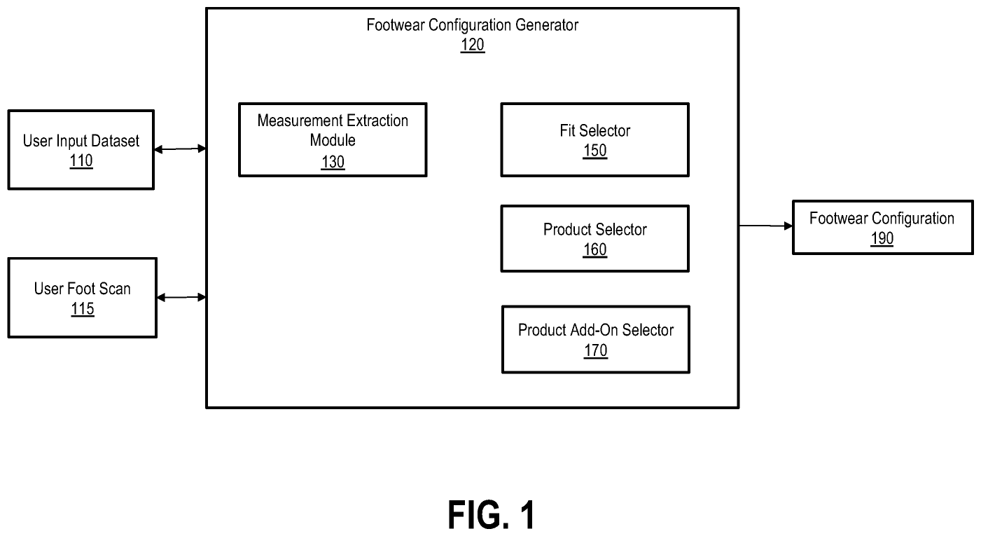

Referring now to FIG. 1, illustrated is a footwear configuration system according to an exemplary embodiment of the present disclosure. The footwear configuration system may be configured to generate a footwear configuration based on a user input dataset 110 and a user foot scan 115. The footwear configuration generator 120 may include a fit selector 150, a product selector 160. In some embodiments, the footwear configuration generator 120 includes a measurement extraction module 130 and a product add-on selector 170.

The footwear configuration system may receive a user input dataset 110 over a network. The user input dataset 110 includes data gathered pertaining to a user foot and information related to the activities of the user. The user input dataset 110 may include information related to a body measurement or an activity measurement. Examples of body measurements include a weight, height, length of the foot, volume of arch, volume of toe, overall volume, expressed preference toe splay, and an expressed preference arch. Examples of activity measurements include user location information, environment preferences, physical limitations, purchase history, aesthetic preferences, and static or moving body metrics.

In some embodiments, the user input dataset 110 may include preferences for a cushion density, a cushion volume, a sock liner arch support, an outsole tread, breathability, water needs, winter needs, and a material feel lacing system. In some embodiments, the user input dataset 110 includes a plurality of activities including training logs, race results, fitness activities, and user movement recorded by a client device. In some embodiments, the user input dataset may include data from machine vision systems capable of determining static or moving body metrics and measurements. The user input data may consider more specific measurements or specific sensitivities related to the user foot.

The user foot scan 115 includes information representative of a user foot. The information may be used to extract measurements of the user foot. The measurements are indicative of the footwear profile for the user. The user foot scan 115 may provide information to the footwear configuration generator 120 not otherwise available to the user. In an embodiment, the user foot scan 115 is obtained by a scanning sensor communicatively coupled to a client device. In some embodiments, the footwear configuration generator 120 provides a prompt via the client device that information (e.g., a scan or an image) is required via the scanning sensor. The footwear configuration generator 120 may provide instructions for operating the scanning sensor via the client device. The scanning sensor may be configured to capture images or obtain measurements of the user foot. Examples of the scanning sensor includes a 3D scanner, a LiDAR, a camera, and/or the like.

The user foot scan 115 may be used to gather more specific information (e.g., dimension measurement) related to the user foot that is not otherwise provided by the user. For example, the user foot scan 115 may include data related to a foot length from heel to longest toe, foot overall volume, foot volume distribution, ball width, toe length, heel width, heel height, ankle height, arch height, arch volume, bunion presence, angle of ball to top of toe, resting foot toe spread, change in toe spread when on standing on toes, change in arch curve during stride, weight transfer by zone of foot, and the like. These measurements may be used individually or as ratios to each other. Additionally, these foot measurements may be used as ratios to another body metric measurement.

The footwear configuration generator 120 may include a fit selector 150. The fit selector 150 is configured to gather accurate information and measurements for a footwear profile based on the user input dataset 110. The fit selector 150 is configured to assemble an accurate representation of the user foot and the features of the desired footwear related to activity, experience, environment, and personal preference. In addition to the user input dataset 110, the fit selector 150 may require a user foot scan 115 to extract a measurement for determining a dimension of the user foot. In some embodiments, the fit selector 150 may generate a model of the user foot based on the user input dataset 110 and the user foot scan 115. The model of the user foot enables the footwear configuration system to select the best product by representing the various dimensions of the user foot. For example, the footwear configuration system may compare the model of the portion of the user foot to the plurality of footwear datasets in a database and identify a match for a feature of the model to a customization of the configurable area of the footwear profile and/or footwear product.

In some embodiments, the fit selector 150 is configured to be communicatively coupled to a database. The database may include a plurality of footwear datasets that the fit selector 150 utilizes to determine features of a user foot based on the user input dataset 110 and/or the user foot scan 115. For example, the fit selector 150 may compare values of the user input dataset 110 against the plurality of footwear datasets found in the database and determine that aggressive arch support is required. In another example, the fit selector 150 may compare values of the user input dataset 110 representative of a pain-inducing experience of the user (e.g., blistering region) against the plurality of footwear datasets found in the database having a similar pain-inducing experience and determine that a mild heel-toe drop is required. The values closely matching other values of other users in the database or satisfying a threshold may be indicative of a configurable area of the shoe.

In some embodiments, the fit selector 150 may utilize a table of footwear feature thresholds for determining footwear features corresponding to the footwear profile. For example, the fit selector 150 may identify a feature of wider toes for a footwear profile based on a value of the user input data satisfying a footwear feature threshold. In another example, the fit selector 150 may identify a feature of an aggressive ankle tilt for a footwear profile based on a value of the user input data satisfying a footwear feature threshold. The footwear feature thresholds may be determined by a predetermined table or generated by an analysis of similar footwear profiles.

The fit selector 150 may apply an algorithm to determine the footwear profile. The algorithm is applied to analyze the user input to determine a feature of the footwear profile. For example, the algorithm may determine a length, width, volume of arch, volume of toe, overall volume, expressed preference toe splay, an expressed preference arch, and the like based on the user input data. The algorithm may determine the footwear profile based on the intersection of information about their body, their preferences, and experience with existing manufacturers. The algorithm may weigh user inputs received from a survey to determine the footwear profile. For example, the algorithm may weigh the historical footwear product size, width, brand preference, affinity for the manufacturer, advantages, and disadvantages of the manufacturer, and the like. The algorithm may weight medical history of the patient, such as bone issues, arch issues, bunion issues, and the height, weight, age, and gender of the user. In some embodiments, the algorithm weighs certain inputs more than other inputs from the user input dataset 110 in determining the footwear profile. For example, the algorithm may place more weight on medical history questions than manufacturer preference questions. In another example, the algorithm may place more weight on a measurement received from a user scan rather than a measurement received from the user.

The product selector 160 is configured to select a product based on footwear profile created by the fit selector 150. The product selector 160 may determine materials, design, style, features, durability, and functionality based on the footwear profile and the user input dataset 110. In some embodiments, the product selector 160 is configured to determine one of a plurality of base models for a user. For example, the product selector 160 may determine base footwear models corresponding to the footwear profiles. Once a base footwear model corresponding to a footwear profile is determined, the process may proceed to the selection of other configurable areas of the footwear. To determine the footwear product, the product selector 160 may utilize a table of footwear feature thresholds for determining the footwear product corresponding to the footwear profile. For example, the fit selector 150 may select a footwear product requiring a wider toe box based on the footwear profile having wider toes that satisfy a footwear feature threshold. In another example, the product selector 160 may select a footwear product with an aggressive heel-to-toe drop based on the footwear profile having an aggressive ankle tilt that satisfied a footwear feature threshold.

In some embodiments, the product selector 160 is configured to be communicatively coupled to a database. The database may include a plurality of footwear datasets that the product selector 160 utilizes for determining features of a user foot based on the footwear profile. For example, the product selector 160 may compare values of the footwear profile having an aggressive arch against the plurality of footwear datasets also having an aggressive arch and identify a footwear product providing aggressive arch support. In another example, the product selector 160 may compare values of a footwear profile associated with a pain-inducing experience (e.g., bunions) of the user against the plurality of footwear datasets having a similar pain-inducing experience and identifying a footwear product having a mild heel-toe drop. The outcome values are indicative of a particular variation in a configurable area of the shoe. In some embodiments, the product selector 160 may be configured to determine which initial shape of footwear to select such as a wider, more square-shaped toe box, tapered toe box, or the like and, based thereon, select one of a plurality of base footwear models.

In some embodiments, the fit selector 150 and the product selector 160 work simultaneously for the footwear configuration process to determine a product experience and configuration suitable for the particular user. Although the fit selector 150 determines the footwear profile, the configurable areas of the footwear may be analyzed simultaneously by the product selector 160. The footwear base model may be a starting point in the consultation process of recommending a footwear while this footwear profile may be performed simultaneously to the product selection.

The footwear configuration system may include a measurement extraction module 130. The measurement extraction module 130 may be configured to receive scans or images of a user foot and extract measurements representative of a portion of the user foot from the scan of the user foot. For example, the measurement extraction tool may extract an arch volume of the user foot based on a 3D scanned image of the user foot. In another example, the measurement extraction tool may extract a toe width reading based on a LiDAR scan of the user foot. In an embodiment, the user foot scan 115 is obtained by a scanning sensor communicatively coupled to a client device 230. Examples of scans may include a measurement reading, an image, or a model.

The measurement extraction module 130 may be used to gather more specific information (e.g., dimension measurement) related to the user foot that is not otherwise provided by the user. For example, the user foot scan 115 may include data from which a dimension related to a foot length from heel to longest toe, foot overall volume, foot volume distribution, ball width, toe length, heel width, heel height, ankle height, arch height, arch volume, bunion presence, angle of ball to top of toe, resting foot toe spread, change in toe spread when on standing on toes, change in arch curve during stride, weight transfer by zone of foot, and the like. These extracted measurements may be used individually or as ratios to each other.

The product selector 160 may be configured to adjust a configurable area of the product selected by the product selector 160. The product add-on selector 170 may be configured to adjust based on a user activity, a user behavior, a user preference, a user experience, or a user condition. The product add-on selector 170 may adjust a configurable area of the product selected. Examples of the configurable area include a footwear length, a footwear width, a footwear volume, heel cushion density, a toe cushion density, a heel cushion volume, an arch support, a tread requirement, a heel-to-toe profile, a water need, a winter need, a lacing system need, and a footwear volume distribution by area. The product selector 160 may be configured to determine which areas of the footwear should be adjusted from the base footwear model. Adjustments to these areas are then determined based on the analyzed user data. In other words, the product selector 160 analyzes the user input data to determine how or how much the selected configurable areas will be adjusted.

The footwear configuration generator 120 may include a product add-on selector. The product add-on selector 170 may be configured to generate configurations for separate components that may be inserted into the footwear for additional support based on the analyzed data. For example, the product add-on selector may be configured to provide a recommendation for an insole insert or sock liner that provides additional volume in the arch of the footwear. Additionally, the separate components may be gaiters that may be added to the outside of the footwear during inclement weather conditions. The present disclosure is not limited to a particular type of components, and any variety of components may be recommended to the user as an optional addition to the footwear.

The footwear configuration generator 120 generates a recommended footwear configuration. The footwear configuration includes a recommendation of a footwear product with the adjusted configurable area based on the fit selector 150 and/or the product selector 160 and/or the product-add on selector. In some embodiments, a manufacturing process of a footwear product may be adjusted to provide the footwear configuration based on the various analyzed data. In other words, the first step in this process is selecting one of a plurality of footwear base models. These footwear base models may be used in the manufacturing of the footwear. Thereafter, based on the user foot measurements, lifestyle, behavior, and preferences as well as environment and other factors described herein, the manufacturing process is further adjusted to vary each of the configurable areas of the footwear. Thus, contemplated herein is not only the recommended footwear configuration but also the adjustment in the manufacturing process to provide such an improved and customized footwear configuration.

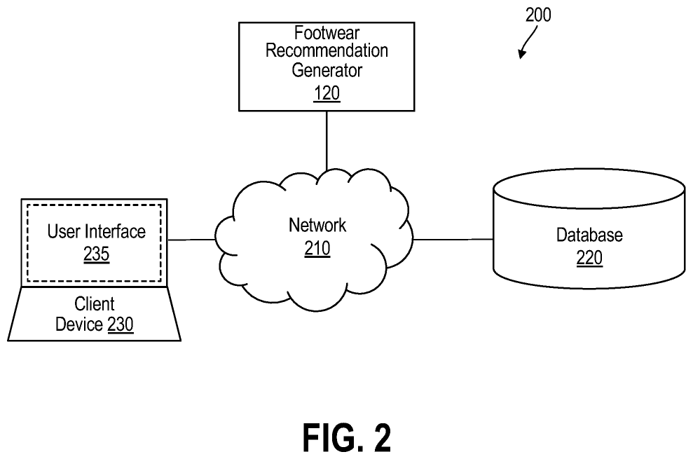

Referring now to FIG. 2, illustrated is a system diagram illustrating an example of a footwear configuration system according to an exemplary embodiment of the present disclosure. Referring to FIG. 2, the footwear configuration system 200 may include a footwear configuration generator 120, a database 220, and a client device 230. As shown in FIG. 2, the footwear configuration generator 120, the database 220, and the client device 230 may be communicatively coupled via a network 210. The network 210 may be a wired network and/or a wireless network including, for example, a local area network (LAN), a virtual local area network (VLAN), a wide area network (WAN), a public land mobile network (PLMN), the Internet, and/or the like.

Methods and systems of the present disclosure can be implemented by way of the footwear configuration generator 120. A footwear configuration may be generated by way of software upon execution by the footwear configuration generator 120. The footwear configuration generator 120 may analyze data from the database 220, which may be associated with a plurality of footwear datasets representative of footwear profiles based on a plurality of user input datasets. For example, the footwear configuration generator 120 may receive a user input dataset 110 from the client device 230, the user input dataset 110 including body measurements or an activity measurement indicative of a footwear profile of a user. The footwear configuration generator 120 may apply a fit selector 150 and a product selector 160 configured to learn the footwear profile of the user and select a corresponding footwear product. The footwear configuration generator 120 may generate a recommended footwear based on the footwear profile and the corresponding footwear product. The recommended footwear may include an adjusted configurable area.

A client device 230 may be communicatively coupled to the network 210. The client device 230 may be configured to acquire the user input dataset 110 from a user. In some embodiments, the client device 230 may be a computer or a mobile device (e.g., a tablet, a phone) that is made available to a user or owned by the user. The client device 230 may be configured to obtain the information from the user through a series of prompts. For example, the client device 230 may provide a survey via a user interface 235 to obtain information related to the user foot. In some embodiments, the client device 230 may be a wristwatch, band, biometric device, mobile device configured to track a plurality of activities including training logs, race results, fitness activities, and user movement. The plurality of activities including the training logs, race results, fitness activities, and user movement may be included in the user input dataset 110 provided by the client device 230.

In some embodiments, a scanning sensor is communicatively coupled to the client device 230. The scanning sensor may be configured to capture images or obtain measurements related to the footwear and, more particularly, the user foot. The client device 230 may include a user interface 235 through which instructions are provided for using the scanning sensor. The scanning sensor may be a 3D scanner, a camera, or a LIDAR. The scanning sensor is configured to pass readings or captured images to the client device 230. In turn, the client device 230 may forward the readings or captured images to the footwear configuration generator 120 for measurement extraction.

The database 220 may be communicatively coupled to the network 210. The database 220 may be configured to store the plurality of footwear datasets representative of footwear profiles. In some embodiments, the plurality of footwear datasets is representative of other user input datasets of other users. The plurality of other user input datasets may be informative as to how a footwear profile and product selection is to be configured for a specific user.

The footwear configuration generator 120 may search through the database 220 to identify customizations of the configurable area associated with the footwear profile. For example, the footwear configuration generator 120 may compare a body measurement, user input data from the user input dataset 110, or a model of a portion of the user foot to the plurality of footwear datasets in the database 220. The footwear configuration generator 120 may match a body measurement, user input data from the user input dataset 110, or a feature of the model to the customization of the configurable area of the footwear profile. The customization may correspond to the body measurement, user input data from the user input dataset 110, or a feature of the model satisfying the footwear feature threshold generated by the plurality of footwear datasets.

In some embodiments, the database 220 may include a set of tendencies for users and the various types of footwear profiles. The set of tendencies may be generated based on the plurality of footwear datasets representative of the body measurement or the activity measurement from other users. Each tendency of the set of tendencies may be representative of a correlation between the body measurement or the activity measurement and a subset footwear dataset of the plurality of the footwear datasets from other users where the subset footwear dataset has the body measurement or the activity measurement. The tendency may correspond to a customizable feature.

The footwear configuration generator 120 may determine an adjustment of a configurable area based on the database 220 with the set of tendencies. The footwear configuration generator 120 may search through the database 220 to identify a tendency associated with the body measurement or the activity measurement associated with the user. The tendency may be generated by an analysis on the plurality of footwear datasets (e.g., historical datasets) of persons having the same body measurement or activity measurement. The tendency may indicate a preference, a disposition, or a correlation between the user foot and a configurable footwear feature related to the footwear profile and/or the footwear product. For example, the footwear configuration generator 120 may compare an activity measurement (e.g., marathon runner) against the historical datasets. The footwear configuration generation may identify a tendency associated with the marathon running activity of the user. The tendency may indicate that persons having the marathon running activity tend to have a carbon-plated insole. The footwear configuration generator 120 may adjust the configurable area (e.g., the sole) in response to matching the activity (e.g., marathon running) with the tendency. For example, the footwear configuration generator 120 may compare a body measurement (e.g., a toe measurement) against the historical datasets. The footwear configuration generator 120 may identify a tendency associated with the toe measurement of the user. The tendency may indicate that persons having the toe measurement tend to have a more voluminous toe box. The footwear configuration generator 120 may adjust a configurable area (e.g., the toe box) in response to matching the body measurement (e.g., toe measurement) with the tendency.

In some embodiments, the database 220 may be configured to receive a query including the foot measurement or the user input dataset 110. The database 220 may be configured to return search results including a customization of the configurable area of the footwear profile. The customization may correspond to the foot measurement or the user input dataset 110 satisfying a footwear feature threshold generated by the plurality of footwear datasets. In some embodiments, the database 220 may be configured to receive a model of a portion of a user foot associated with the query. The database 220 may be configured to return search results including a customization of the configurable area of the footwear profile, the customization corresponding to the model of a portion of a user foot satisfying a footwear feature threshold generated by the plurality of footwear datasets.

Devices, systems, compositions, and methods of the present disclosure may be used for various applications, such as, for example, generating a footwear configuration based on the footwear profile and an adjusted configurable area of the selected footwear product. The entities of the footwear configuration system 1200 may have distinct roles in generating a footwear configuration. For example, the footwear configuration generator 120 may generate a footwear configuration based on the user input dataset 110 received from the client device 230. The footwear configuration generator 120 may compare body measurements or activity measurements to the footwear datasets in the database 220. The database 220 may include customizations or tendencies created by an analysis of footwear datasets. The footwear configuration generator 120 may match a customization or a tendency corresponding to the body measurements or the activity measurements of other users to the current user based on the body measurements or activity measurements received from the client device 230.

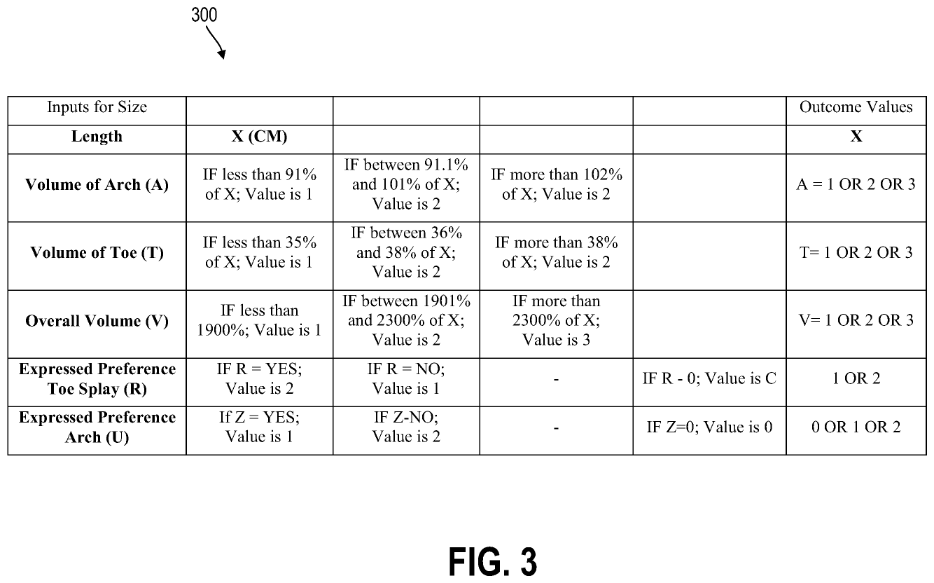

Referring now to FIG. 3, illustrated is configuration output table 300 including configuration outputs based on user input data for the footwear configuration process according to an exemplary embodiment of the present disclosure. The configuration outputs may assist the fit selector 150 in determining a footwear profile of the user. The configuration outputs may correspond to a feature or characteristic of the user foot. For example, the configuration output may correspond to a volume of an arch, a volume of a toe, an overall volume, an expressed preference toe splay, and an expressed preference arch.

The values from the user input dataset 110 may be applied to determine the configuration outputs associated with the footwear profile of the user. Values extracted from the user input dataset 110 may include body measurements or activity measurements. Configuration outputs may include thresholds (e.g., footwear feature thresholds) to determine the feature or characteristic of the footwear profile associated with the value from the user input dataset 110. For example, if a body measurement corresponds to a configuration output associated with an overall volume, the value of the body measurement is compared to the thresholds for overall volume. If the value satisfies the threshold, then the footwear profile is updated to more accurately represent the dimensions of the user foot. The fit selector 150 may update the footwear profile based on the value from the user input dataset 110 satisfying the threshold. The configuration outputs may be indicative of a footwear profile to be used as a starting point for the customization process.

As shown in FIG. 3, the inputs are compared to various footwear feature thresholds to output a footwear profile to be used as a base for the product selection process. The fit selector 150 may utilize the footwear feature thresholds for determining the features of the user foot corresponding to the footwear profile. For example, the fit selector 150 may identify a foot profile having wider toes based on a value of the user input data satisfying a footwear feature threshold. In another example, the fit selector 150 may identify a foot profile having an aggressive ankle tilt based on a value of the user input data satisfying a footwear feature threshold. In an embodiment, the footwear feature thresholds may be determined based on the base footwear models and/or standard sizing.

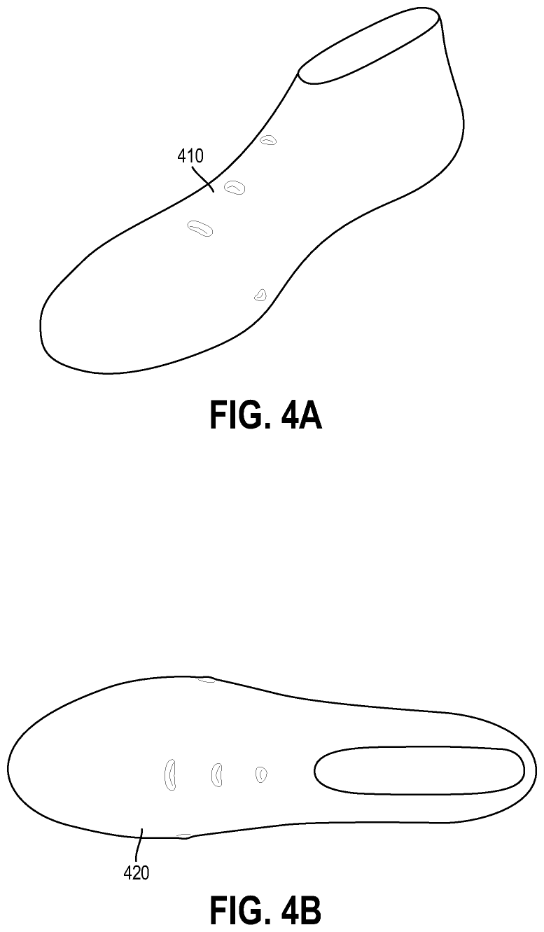

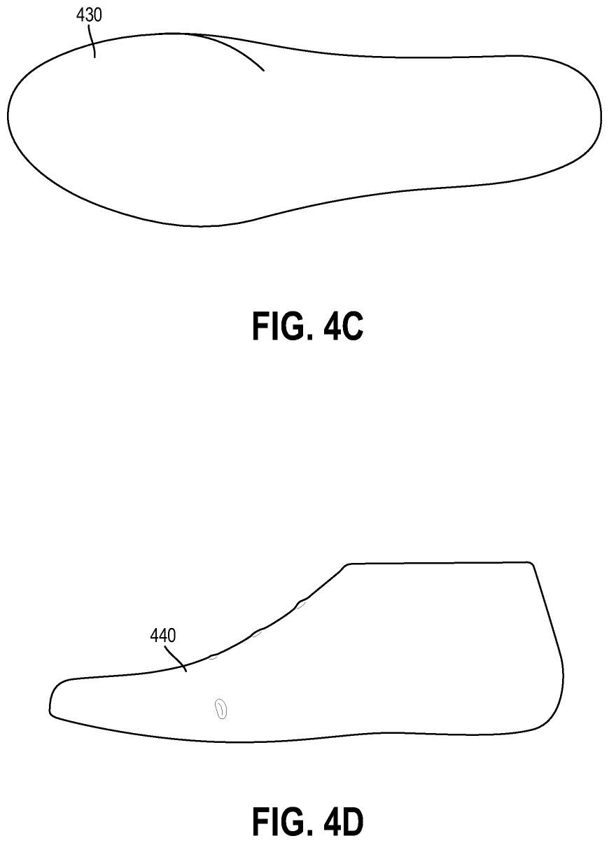

Referring now to FIGS. 4A-4D, illustrated are different views of an example of footwear profiles according to an exemplary embodiment of the present disclosure. Front footwear profile 410 shows a front view of a footwear profile, top footwear profile 420 shows a top view of a footwear profile, bottom footwear profile 430 shows a bottom view of a footwear profile, and side footwear profile 440 shows a side view of a footwear profile. A footwear profile may represent features or characteristics of the user foot, but need not be a model or pictorial representation of the user foot. These footwear profiles may vary in their various features, including toe box, overall volume, and width. Additionally, the footwear profile may illustrate different features or characteristics of the user input dataset 110.

The footwear profile may assist the product selector 160 in selecting footwear products based on the different features of the user foot, including sizes, lengths, arch shapes, volumes, and/or the like. In one example, the footwear profile may capture data representative of a user foot with a toe area average in volume, a midfoot and heel regions narrower than expected. In another example, the footwear profile may capture data representative of a user foot with a toe area that is more rectangular than average, additional volume in height, and a midfoot and heel regions in a mid-range of overall volume. In another example, the footwear profile may capture data representative of a user foot with a toe area that tapers in volume, a larger overall volume, and in a wider width at the midfoot and heel regions compared to average feet.

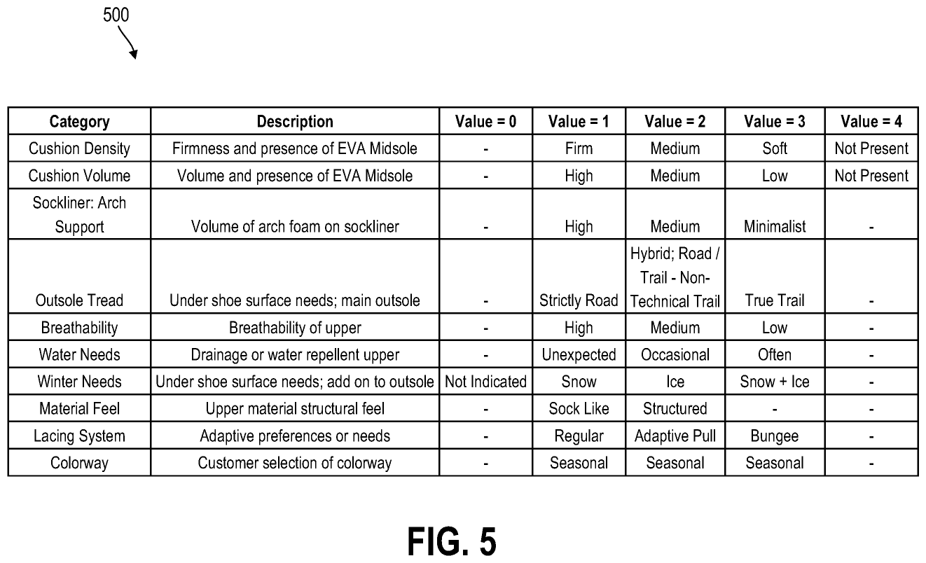

Referring now to FIG. 5, illustrated is a guided consultative experience table 500 representative of the guided consultative experience according to an exemplary embodiment of the present disclosure. The guided consultative experience may be used to gather the user input dataset 110. The guided consultative experience may provide a series of selections related to a category. The series of selections enables the user to indicate a preference of in their footwear configuration that may not be otherwise indicated by a body measurement. In some embodiments, the guided consultative experience may assist in indicating an activity measurement. As shown in FIG. 5, the categories may include a cushion density, a cushion volume, a sock liner arch support, an outsole tread, breathability, water needs, winter needs, and a material feel lacing system. Other categories may be related to activity, experience, environment, and personal preference.

In some embodiments, the guided consultative experience may assist in indicating an activity measurement. For example, an outsole tread-related input is indicative of what type of surface is needed underneath the footwear. A user may input that the footwear will be worn merely on, for example, road surfaces, on trails or uneven terrain, varying degrees of trail technicality (e.g., soft, hard-packed dirt), or a combination thereof. In some embodiments, each one of these user inputs may correlate to an output value for the configurable area. For example, a different cushion volume will be determined (high, medium, or low) based on the user input dataset 110.

In some embodiments, the different categories may include cushion density, which relates to the firmness of the midsole as well as presence of ethylene-vinyl acetate (EVA) or other similar type of foam. The different categories may include a cushion volume, which relates to the volume of the midsole. The different categories may include sock liner or arch support, which relate to the volume of arch foam on the sock liner of the footwear. The different categories may include breathability, which relates to the breathability of the upper portion of the footwear. The different categories may include water needs, which relates to the drainage or water repellant feature of the footwear. The different categories may include winter needs, which relates to an added layer to the outsole under the footwear. The different categories may include material feel, which relates to the upper material structural feel. The different categories may include a lacing system, which relates to adaptive preference or needs of a user for lacing the footwear. The different categories may include colorway, which relates to user preference of the color of the footwear, or the like. The present disclosure is not limited to these particular categories and these are merely examples. Each of the categories described above may have different ranges or levels, which determine to what extent the configurable area is adjusted.

In some embodiments, the environment in which the footwear intends to be used is an important consideration. This may also include a range of environments for which suitable materials may be selected based on the environment. For example, one material may be treated with waterproofing for a winter environment while still providing warmth and having low permeability for debris. In another example, a material may provide a highest level of breathability, a highest level of drainage, and moderate permeability for dust and debris for desert environments.

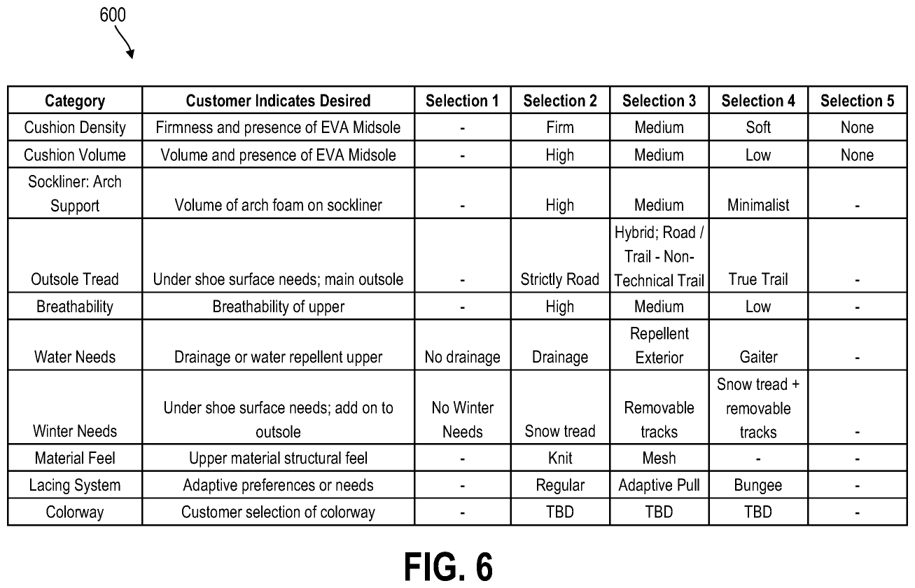

Referring now to FIG. 6, illustrated is an experienced consultative experience table 600 representative of a consultative experience for more experienced users according to an exemplary embodiment of the present disclosure. The guided consultative experience may include fewer options for new users in comparison to more experienced user who prefer to provide more inputs for configurable areas of the footwear product.

After a first purchase, the footwear configuration generator 120 may be configured to store purchase information related to the generated footwear recommendation in a memory or database 220. This information may be stored as a user profile accessible during the guided consultative experience as further data inputs for the user input dataset 110. Accordingly, when a new footwear recommendation request is received, the footwear configuration generator 120 may be configured to access the user profile stored in the database 220 and determine changes in new user data compared to the data in the user profile during the guided consultative experience. For example, the new user data may be input related to a problem area in a zone or region of the foot or a change in environment preferences. These changes will be analyzed in comparison with the user profile during the guided consultative experience to output a new adjusted footwear recommendation for a user.

The consultative experiences of FIGS. 5 and 6 may be analyzed to determine what level of adjustment is required at different regions of the footwear. Other user data is also included in the user input dataset 110 and analyzed to adjust the configurable areas of the footwear. For example, the user input dataset 110 also takes into consideration user preferences. The data may be gathered not only from user inputs as described above, but also from a variety of sources.

The user input dataset 110 may include input using surveys with information entered by the user. The surveys may be presented at client devices including a mobile application, web browser, text message, or other user interfaces. An intake survey may be presented to a new user to begin a registration process. Existing users may also be prompted with a survey to provide feedback on past purchases. Additionally, an existing user may enter feedback at will between footwear purchases. For example, a user may notice an area of discomfort and access a mobile application, send a user service email, or the like providing immediate feedback on the area of discomfort. Accordingly, upon a next purchase, the footwear will be adjusted to improve the discomfort previously experienced at a particular configurable area. In some embodiments, this feedback may be collected in real-time.

Both a new user and an existing user may also provide input information related to other athletic or non-athletic footwear and issues related thereto as well as current or previous product add-ins (e.g., insoles, orthotics, gel cushioning etc.). Additionally, users may input information related to physical and athletic history. This information may include injury history, injury treatment history, currents areas of pain, running mileage volume history, pregnancy and birth history, or the like.

User input datasets may also include user preferences related to any area of the footwear. Users may have particular tendencies or preferences in footwear that should be taken into consideration in the footwear configuration process. Such preferences may include information related to underfoot sensation or arch support, underfoot cushioning density, underfoot cushioning volume, other underfoot preferences, drop or height difference between heel and toe (e.g., heel-toe offset), upper shoe material (e.g., structured, less structured, protected upper region, sock-like, knit, mesh, etc.), product weight, warmth (e.g., cold or warm climate), breathability (e.g., quick drain, cover-optional), waterproof feature, tread (e.g., optimal for road, trail, hiking, combination), fit of product (e.g., width in the toe box), overall width, socks to be worn, and environment (e.g., dust/dirt, adaptive weather, etc.). These are, of course, in addition to user preferences of general aesthetic features such as colors and materials.

User input datasets may also include data from machine vision systems capable of determining static or moving body metrics and measurements. These systems may be configured to communicate the footwear configuration generator 120 via various communication techniques. Accordingly, the information acquired by the machine vision systems may be transmitted to the footwear configuration generator 120. Similarly, other tracking systems may communicate with the controller such as wearable movement trackers, fitness machines, or similar training platforms. For example, training and activity logging systems may be configured to acquire information related to the exercise being performed by the user. This information may include pace, stride, distance, time, inclination, steps, step length, walking asymmetry, route, and the like. These type of tracking systems are also capable of obtaining health data such as heart rate, respiratory information, vitals, mobility, and the like.

Additionally, a user input datasets include various tracked group exercises. This may include road races, exercise classes, and the like. Results from these types of activities may also be logged and communicated with the system of the present disclosure. The user may also perform manual measurements and enter these onto the system as data input.

Further, the user input datasets may be further enhanced by considering more detailed aspects. For example, the present disclosure considers average step counts, step trends over time, moving speed (e.g., top recorded or average), activity categories or types (e.g. cardio, high intensity training, weight training, etc.), activity counts (e.g., how many hours, days, etc. of consistent activity), activity volume metrics, activity intensity metrics, average weekly mileage, change in mileage or weekly mileage, surface area distribution (e.g., pavement, cement, dirt trail, fire roads, technical trail, snow, rain, etc.), elevation change, elevation change over time, and the like.

There are many aspects or measurements of the foot that are important to consider in the customization process and affect the areas of the footwear that are configurable. These measurements may include foot length from heel to longest toe, foot overall volume, foot volume distribution, ball width, toe length, heel width, heel height, ankle height, arch height, arch volume, bunion presence, angle of ball to top of toe, resting foot toe spread, change in toe spread when on standing on toes, change in arch curve during stride, weight transfer by zone of foot, and the like. These measurements may be used individually or as ratios to each other. Additionally, these foot measurements may be used as ratios to another body metric measurement.

Other measurements for the user input dataset 110 that may affect the outcome values of the footwear recommendation include body measurements such as gait measurements, body weight, height, gender, and sex. For example, different body weights may apply different pressures on the different zones of the foot and thus, these zones should be configured differently for maximum comfort in the footwear. Additionally, geographic and demographic information may be gathered. For example, the system may receive inputs related to zip code, additional zip codes (e.g., other regions where footwear will be used), humidity or other weather conditions, weather patterns, elevation of environment, age, ethnicity, age, sex, gender pronouns, etc.

Based on all of the above-discussed data that is considered in providing the footwear recommendation, the fit selector 150 and product selector 160 may be configured to determine a length of the footwear, internal volume capacity of the footwear by foot zone, volume distribution of the footwear by foot zone, shape of the toe box, and amount of arch support. Accordingly, all this data is analyzed to select the different configurable areas of a footwear based first on which fit model is selected.

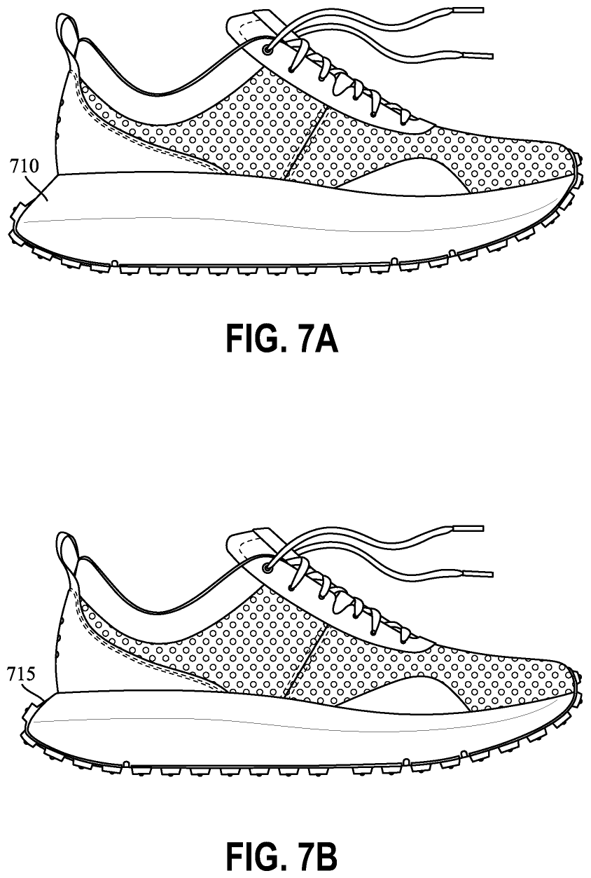

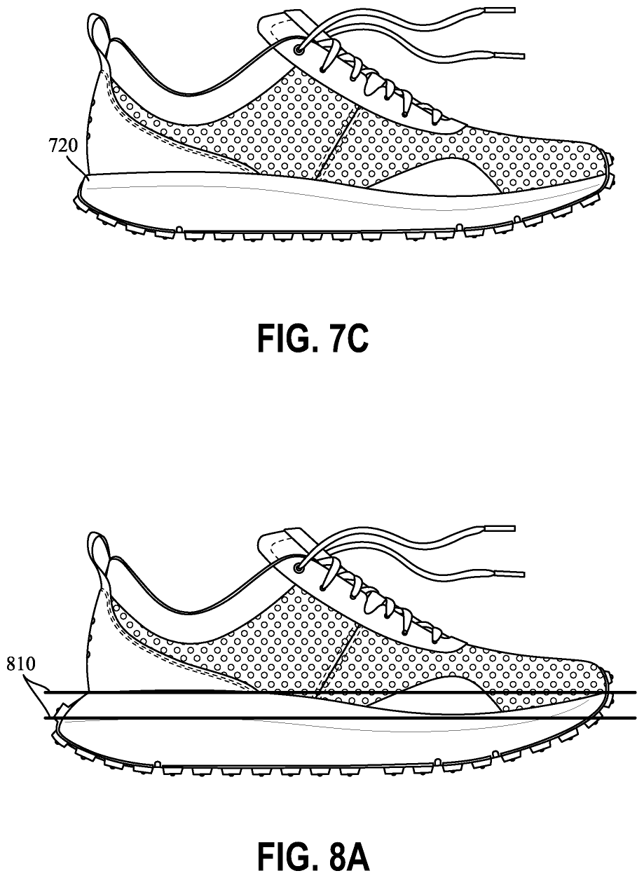

Referring now to FIGS. 7A-7C, illustrated are different configurations of the midsole volume according to an exemplary embodiment of the present disclosure. The midsole is specifically the region of the footwear that is sandwiched between the upper sole and the outsole and provides cushioning and rebound. In other words, this region of the footwear aids in preventing a user from feeling sharpness or hardness from objects that are stepped on.

In particular, FIG. 7A shows an example of a high-volume midsole 710, FIG. 7B shows an example of a medium-volume midsole 715, and FIG. 7C shows an example of a low-volume midsole 720. Additionally, although not shown, each variation of midsole volume may also include at least two foam density variations. In other words, each midsole volume configuration may provide a different volume of cushion and different density of cushion. This variation specifically offers different levels of flexibility in the underfoot. Each of these different midsole volumes may be selected based on the various data that is collected by the product selector 160. For example, the selection of the midsole volume and foam density may be based on prior shoe experience, body weight, and personal preference.

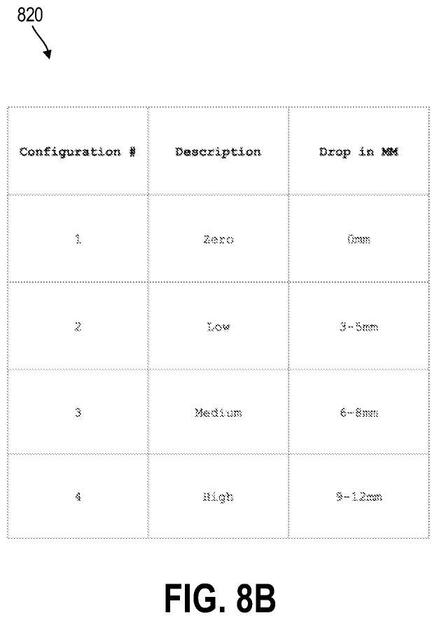

Referring now to FIG. 8A, illustrated is an offset representative of height difference between the heel and toe regions according to an example embodiment. The offset is the stack height difference between the cushioning underneath the heel and toe regions, and is shown by the two horizontal lines 810 across the footwear in FIG. 8A. Referring now to FIG. 8B, illustrated is the offset table 820 showing different configuration possibilities in which the offset varies according to an exemplary embodiment of the present disclosure. Offset table 820 may provide the range in millimeters of offset variations. Four configuration variations are shown but further variations may be contemplated in different offset ranges.

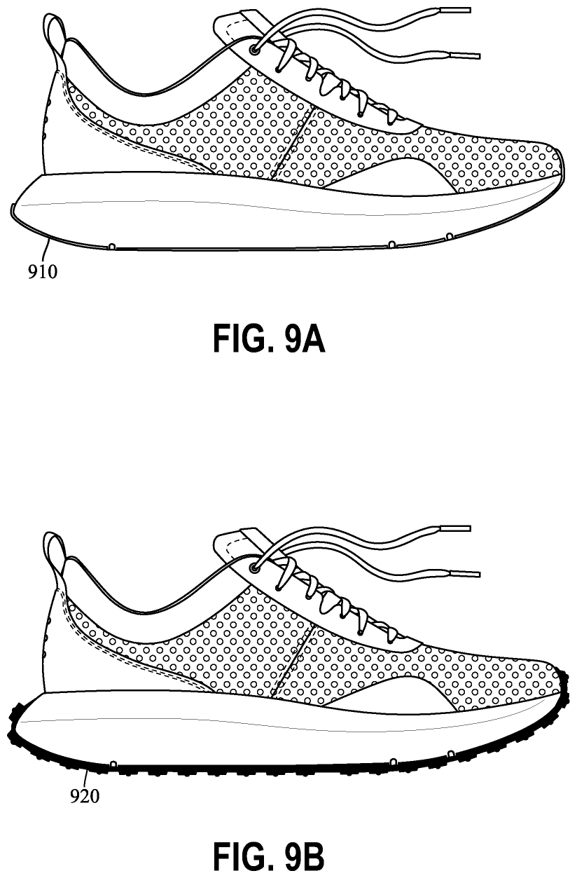

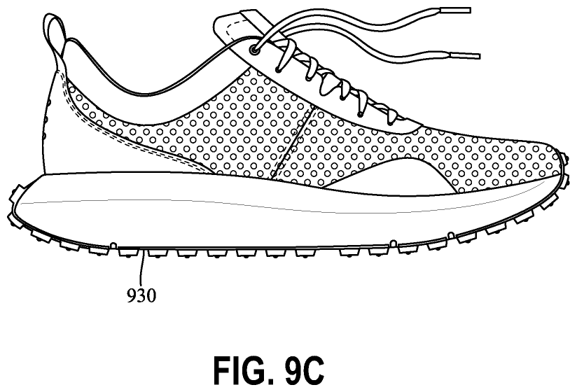

Referring now to FIGS. 9A-9C, illustrated are different tread options on the footwear. In particular, FIG. 9A shows a smoother tread 910, which may be appropriate as a road tread for users who will tend to use the footwear on road or pavement surfaces. FIG. 9B shows a trail tread 920, which may be more appropriate for users intending to use the footwear on substantially uneven terrain. FIG. 9C shows a hybrid tread 930, which may be appropriate for mixed-used footwear.

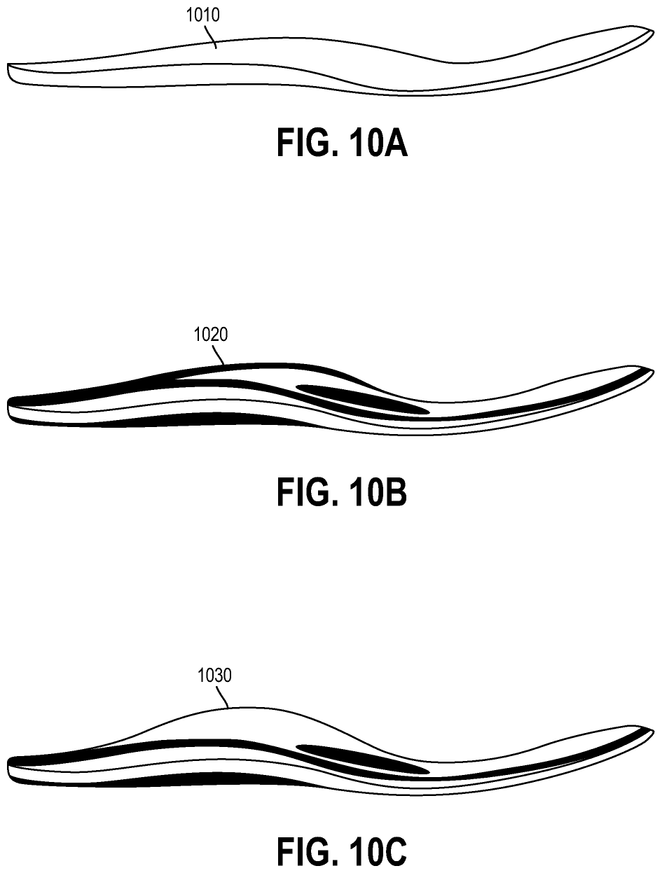

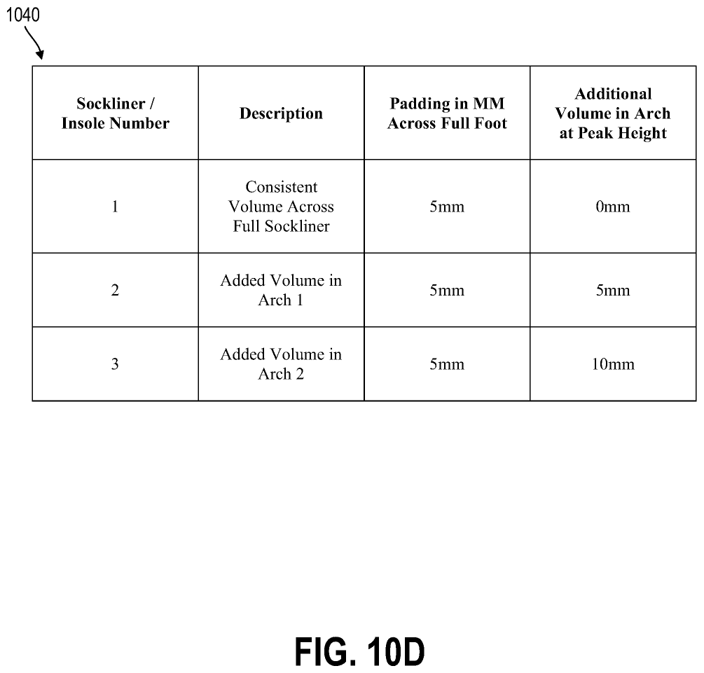

Referring now to FIGS. 10A-10C, illustrated are examples of insoles having different levels of arch support generated by the product add-on selector 170. The product add-on selector may be configured to generate configurations for separate components that may be inserted into the footwear for additional support based on the analyzed data. For example, the product add-on selector may be configured to provide a recommendation for an insole insert or sock liner that provides additional volume in the arch of the footwear. FIG. 10A-10C shows examples of insoles having different levels of arch support. FIG. 10D shows an insole configuration table 1040 including insoles with varying pad thicknesses and arch volumes for each insole. For example, FIG. 10A shows a non-contoured insole 1010 and corresponds to the first insole in the insole configuration table 1040, FIG. 10B shows a mid-range arch support 1020 and corresponds to the second insole in the insole configuration table 1040, and FIG. 10C shows a high arch support 1030 and corresponds to the third insole in the insole configuration table 1040. The numerical values for the second insole may be added values to that of the first insole and similarly, the numerical values for the third insole may be added values to those of the second insole.

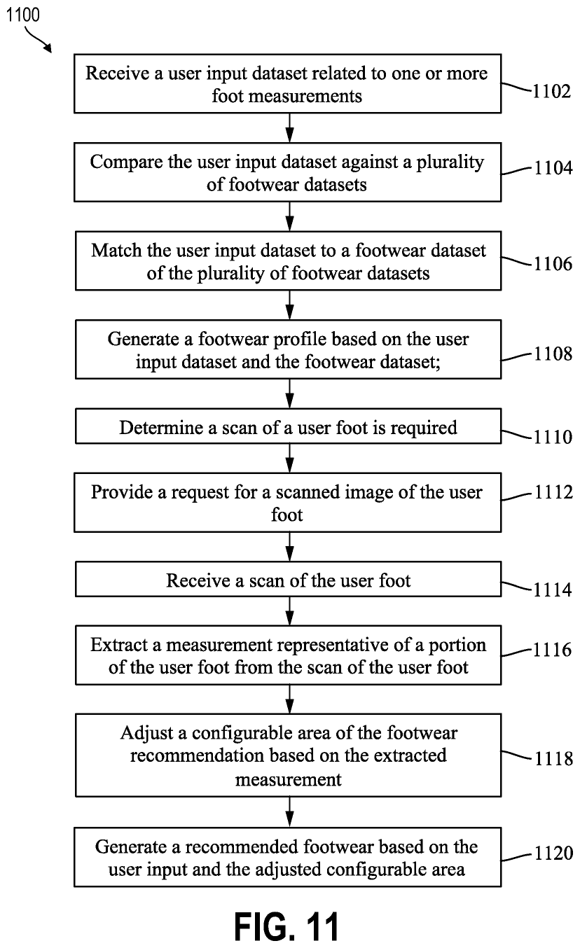

Referring now to FIG. 11, illustrated is a flowchart depicting an example of a process for generating a footwear configuration in accordance with some example embodiments.

At 1102, the footwear configuration generator 120 may receive a user input dataset 110 related to footwear. For example, the footwear configuration generator 120 may receive the results of a survey about the user foot, health, medical history, and activity from an in-store kiosk.

At 1104, the footwear configuration generator 120 may compare the user input dataset 110 against a plurality of footwear datasets, the user input dataset 110 including at least one of a body measurement or an activity measurement. For example, the footwear configuration generator 120 may compare the typical shoe size, weight, manufacturer preference, and distance running activities against a plurality of footwear datasets of persons who also have that shoe size, weight, manufacturer preference, and distance running activities.

At 1106, the footwear configuration generator 120 may match the user input dataset 110 to a footwear dataset of the plurality of footwear datasets. For example, the footwear configuration generator 120 may identify a subset of the plurality of footwear datasets of persons who have the shoe size, weight, manufacturer preference, and distance running activities corresponding to the user.

At 1108, the footwear configuration generator 120 may generate a footwear profile based on the user input dataset 110 and the footwear dataset. For example, the fit selector 150 may create the footwear profile capturing different features or characteristics of the user input dataset 110 related to the user foot. The footwear profile may assist the product selector 160 in selecting footwear products based on the different features of the user foot, including sizes, lengths, arch shapes, volumes, midfoot, and heel regions. The footwear profile may correspond to a base footwear model that includes configurable areas.

At 1110, the footwear configuration generator 120 may determine a scan of a user foot is required based on the user input dataset 110. For example, the user may indicate in the user survey that blistering is common in a particular region of the foot and that chronic discomfort is associated with shoe products of a preferred manufacturer. In response to these survey results, the system determines that further configuration of the footwear configuration is needed.

At 1112, the footwear configuration generator 120 may provide a request for the scan of the user foot. For example, the footwear configuration generator 120 may request the user to upload the tracked fitness metrics from a fitness band and to perform a series of measurements using a scanning sensor communicatively coupled to the in-store kiosk. At 1114, the scan of the user foot is received.

At 1116, the footwear configuration generator 120 may extract a foot measurement representative of a portion of the user foot from the scan of the user foot. For example, the footwear configuration generator 120 may receive a 3D scan identifying the user foot has a sensitive heel and fitness metrics indicating the user does frequent uphill/downhill running.

At 1118, the footwear configuration generator 120 may adjust a configurable area of the footwear profile based on the foot measurement. For example, the footwear configuration generator 120 may decrease the heel cushion density in response to identifying the sensitive heel. In another example, the footwear configuration generator 120 may increase the midsole volume in response to the frequent uphill/downhill running.

At 1120, the footwear configuration generator 120 may generate a recommended footwear configuration based on the footwear profile and the adjusted configurable area. For example, the footwear configuration generator 120 may generate a recommended footwear configuration including the decreased heel cushion density and the increased the midsole volume.

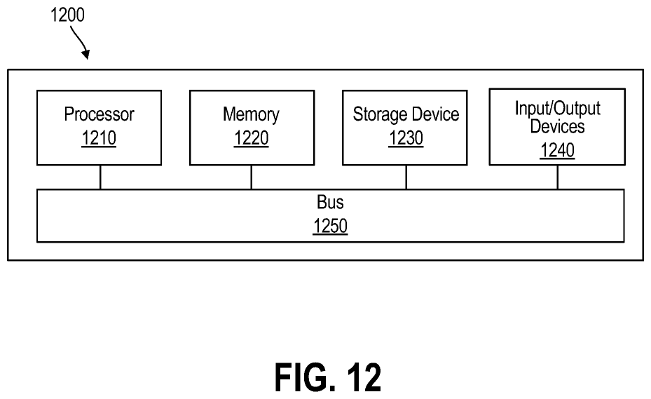

Referring now to FIG. 12, illustrated is a block diagram illustrating an example of a computing system 1200 consistent with implementations of the current subject matter. Referring to FIGS. 1-12, the computing system 1200 may be used to implement the footwear configuration generator 120 and/or any component therein. For example, the computing system 1200 may implement a user equipment, a personal computer, or a mobile device.

As shown in FIG. 12, the computing system 1200 may include a processor 1210, a memory 1220, a storage device 1230, and an input/output device 1240. The processor 1210, the memory 1220, the storage device 1230, and the input/output device 1240 may be interconnected via a system bus 1250. The processor 1210 is capable of processing instructions for execution within the computing system 1400. Such executed instructions may implement one or more components of, for example, the footwear configuration generator 120 for adjusting configurable areas and generating footwear configurations. In some example embodiments, the processor 1210 may be a single-threaded processor. Alternately, the processor 1210 may be a multi-threaded processor. The processor 1210 is capable of processing instructions stored in the memory 1220 and/or on the storage device 1230 to display graphical information for a user interface provided via the input/output device 1440.

The memory 1220 is a non-transitory computer-readable medium that stores information within the computing system 1200. The memory 1220 may store data structures representing configuration object databases, for example. The storage device 1230 is capable of providing persistent storage for the computing system 1200. The storage device 1230 may be a floppy disk device, a hard disk device, an optical disk device, or a tape device, or other suitable persistent storage means. The input/output device 1240 provides input/output operations for the computing system 1200. In some example embodiments, the input/output device 1240 includes a keyboard and/or pointing device. In various implementations, the input/output device 1240 includes a display unit for displaying graphical user interfaces.

According to some example embodiments, the input/output device 1240 may provide input/output operations for a network device. For example, the input/output device 1240 may include Ethernet ports or other networking ports to communicate with one or more wired and/or wireless networks (e.g., a local area network (LAN), a wide area network (WAN), the Internet, a public land mobile network (PLMN), and/or the like).

In some example embodiments, the computing system 1200 may be used to execute various interactive computer software applications that may be used for organization, analysis, and/or storage of data in various formats. Alternatively, the computing system 1200 may be used to execute any type of software applications. These applications may be used to perform various functionalities, e.g., planning functionalities (e.g., generating, managing, editing of spreadsheet documents, word processing documents, and/or any other objects, etc.), computing functionalities, communications functionalities, etc. The applications may include various add-in functionalities or may be standalone computing items and/or functionalities. Upon activation within the applications, the functionalities may be used to generate the user interface provided via the input/output device 1240. The user interface may be generated and presented to a user by the computing system 1200 (e.g., on a computer screen monitor, etc.).

The system and method described herein provide an advanced analysis for outputting a footwear configuration recommendation based on a combination of the user input dataset. By considering factors personal to a specific user, the user is able to receive a customized footwear beyond size, width, and aesthetics. No conventional footwear provides flexibility in adjusting all regions of the shoe. The present disclosure combines all different types of data to provide a truly personalized configuration for a footwear. Additionally, the present disclosure provides the benefit of building user profiles to continuously adjust areas for future footwear purchases. In other words, the present disclosure learns the user and adjusts the footwear recommendation based on changes in data. Accordingly, the present disclosure provides an improved footwear that considers personal foot characteristics as well as user lifestyle or behavior and what type of environment the footwear will be used in.

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

What is claimed is:

1. A method comprising:
receiving, using at least one processor, a user input dataset related to footwear;
comparing, using the at least one processor, the user input dataset against a plurality of footwear datasets, the user input dataset including at least one of a body measurement or an activity measurement;
matching, using the at least one processor and based on the comparing, the user input dataset to a footwear dataset of the plurality of footwear datasets;
generating, using the at least one processor and based on the matching, a footwear profile based on the user input dataset and the footwear dataset;
determining, using the at least one processor and based on the user input dataset, a scan of a user foot is required;
providing, using the at least one processor and in response to determining the scan of the user foot is required, a request for the scan of the user foot;
receiving, using the at least one processor and in response to providing the request, the scan of the user foot;
extracting, using the at least one processor, a foot measurement representative of a portion of the user foot from the scan of the user foot;
adjusting, using the at least one processor, a configurable area of the footwear profile based on the foot measurement; and
generating, using the at least one processor, a recommended footwear configuration based on the footwear profile and the adjusted configurable area.

2. The method of claim 1, further comprising:
presenting, using the at least one processor, a query including at least one of the foot measurement or the user input dataset at a database communicatively coupled to the at least one processor, the database configured to store the plurality of footwear datasets representative of footwear profiles based on a plurality of user input datasets;
receiving, using the at least one processor and based on the plurality of footwear datasets, a customization of the configurable area associated with the footwear profile, the customization corresponding to the at least one of the foot measurement or the user input dataset satisfying a footwear feature threshold generated by the plurality of footwear datasets; and
adjusting, using the at least one processor, the configurable area of the footwear profile based on the customization.

3. The method of claim 2, further comprising:
generating, using the at least one processor, a model of the portion of the user foot;
comparing, using the at least one processor, the model of the portion of the user foot to the plurality of footwear datasets in the database;
matching, using the at least one processor, a feature of the model to the customization of the configurable area of the footwear profile, the customization corresponding to the at least one of the foot measurement or the user input dataset satisfying the footwear feature threshold generated by the plurality of footwear datasets; and
adjusting, using the at least one processor, the configurable area of the footwear profile based on the customization.

4. The method of claim 2, wherein the database further includes a set of tendencies for footwear profiles, the set of tendencies generated based on the plurality of footwear datasets, the footwear datasets being representative of at least one of the body measurement or the activity measurement from other users, and a tendency of the set of tendencies being representative of a correlation between the at least one of the body measurement or the activity measurement and a subset footwear dataset of the plurality of the footwear datasets having the at least one of the body measurement or the activity measurement,
wherein the tendency corresponds to a customizable feature.

5. The method of claim 1, wherein the user input dataset is acquired from a client device communicatively coupled to the at least one processor, wherein the scan is obtained from a scanning sensor communicatively coupled to the client device, the scanning sensor being configured to perform at least one of capture images or obtain measurements, wherein the client device tracks a plurality of activities including training logs, race results, fitness activities, and user movement, and wherein the scanning sensor further comprises at least one of a 3D scanner, a camera, or a LIDAR.

6. The method of claim 1, further comprising:
generating, using the at least one processor, a user profile based on the recommended footwear configuration and corresponding user input and user data;
storing, using the at least one processor, the user profile in a database; and
presenting, using the at least one processor, the recommended footwear configuration based on the footwear profile and the adjusted configurable area.

7. The method of claim 1, wherein the configurable area of the footwear profile includes a combination of a footwear length, a footwear width, a footwear internal volume capacity, and a footwear volume distribution by area.

8. The method of claim 1, wherein the body measurement includes at least one of a user foot length, an arch volume, a toe volume, an overall volume, a toe splay preference, and an arch preference.

9. The method of claim 1, wherein the user input dataset further includes user location information, environment preferences, physical limitations, purchase history, aesthetic preferences, and static or moving body metrics.

10. The method of claim 1, wherein the activity measurement includes user location information, environment preferences, physical limitations, purchase history, aesthetic preferences, and static or moving body metrics.

11. A system comprising:
at least one processor, and
at least one non-transitory storage media storing instructions that, when executed by the at least one processor, cause the at least one processor to perform operations comprising:
receiving a user input dataset related to footwear;
comparing the user input dataset against a plurality of footwear datasets, the user input dataset including at least one of a body measurement or an activity measurement;
matching, based on the comparing, the user input dataset to a footwear dataset of the plurality of footwear datasets;
generating, based on the matching, a footwear profile based on the user input dataset and the footwear dataset;
determining, based on the user input dataset, a scan of a user foot is required;
providing, in response to determining the scan of the user foot is required, a request for the scan of the user foot;
receiving, in response to providing the request, the scan of the user foot;
extracting a foot measurement representative of a portion of the user foot from the scan of the user foot;
adjusting a configurable area of the footwear profile based on the foot measurement; and
generating a recommended footwear configuration based on the footwear profile and the adjusted configurable area.

12. The system of claim 11, further comprising a database communicatively coupled to the processor, the database configured to store the plurality of footwear datasets representative of footwear profiles based on a plurality of user input datasets, wherein the operations further comprise:
presenting a query including at least one of the foot measurement or the user input dataset at the database;
receiving, based on the plurality of footwear datasets, a customization of the configurable area associated with the footwear profile, the customization corresponding to the at least one of the foot measurement or the user input dataset satisfying a footwear feature threshold generated by the plurality of footwear datasets; and
adjusting the configurable area of the footwear profile based on the customization.

13. The system of claim 12, wherein the operations further comprise:
generating a model of the portion of the user foot;
comparing the model of the portion of the user foot to the plurality of footwear datasets in the database;
matching a feature of the model to the customization of the configurable area of the footwear profile, the customization corresponding to the at least one of the foot measurement or the user input dataset satisfying the footwear feature threshold generated by the plurality of footwear datasets; and
adjusting the configurable area of the footwear profile based on the customization.

14. The system of claim 12, wherein the database further includes a set of tendencies for footwear profiles, the set of tendencies generated based on the plurality of footwear datasets, the footwear datasets being representative of at least one of the body measurement or the activity measurement from other users, and a tendency of the set of tendencies being representative of a correlation between the at least one of the body measurement or the activity measurement and a subset footwear dataset of the plurality of the footwear datasets having the at least one of the body measurement or the activity measurement,
wherein the tendency corresponds to a customizable feature.

15. The system of claim 11, further comprising:
a client device configured to acquire the user input dataset from a user;
a scanning sensor communicatively coupled to the client device, the scanning sensor configured to perform at least one of capture images or obtain measurements;
wherein the client device tracks a plurality of activities including training logs, race results, fitness activities, and user movement; and
wherein the scanning sensor further comprises at least one of a 3D scanner, a camera, or a LIDAR.

16. The system of claim 11, wherein the operations further comprise:
generating a user profile based on the recommended footwear configuration and corresponding user input and user data;
storing the user profile in a database; and
presenting the recommended footwear configuration based on the footwear profile and the adjusted configurable area.

17. The system of claim 11, wherein the configurable area of the footwear profile includes a combination of a footwear length, a footwear width, a footwear internal volume capacity, and a footwear volume distribution by area.

18. The system of claim 11, wherein the body measurement includes at least one of a user foot length, an arch volume, a toe volume, an overall volume, a toe splay preference, and an arch preference.

19. The system of claim 11, wherein the user input dataset further includes user location information, environment preferences, physical limitations, purchase history, aesthetic preferences, and static or moving body metrics.

20. The system of claim 11, wherein the activity measurement includes user location information, environment preferences, physical limitations, purchase history, aesthetic preferences, and static or moving body metrics.

21. A non-transitory computer-readable storage medium comprising at least one program for execution by one or more processors of a first device, the at least one program including instructions which, when executed by the one or more processors, cause the first device to perform operations comprising:
receiving a user input dataset related to footwear;
comparing the user input dataset against a plurality of footwear datasets, the user input dataset including at least one of a body measurement or an activity measurement;
matching, based on the comparing, the user input dataset to a footwear dataset of the plurality of footwear datasets;
generating, based on the matching, a footwear profile based on the user input dataset and the footwear dataset;
determining, based on the user input dataset, a scan of a user foot is required;
providing, in response to determining the scan of the user foot is required, a request for the scan of the user foot;
receiving, in response to providing the request, the scan of the user foot;
extracting a foot measurement representative of a portion of the user foot from the scan of the user foot;
adjusting a configurable area of the footwear profile based on the foot measurement; and
generating a recommended footwear configuration based on the footwear profile and the adjusted configurable area.
